(19) United States
(12) Patent Application Publication
(10) Pub. No.: US 2006/0113811 A1
(43) Pub. Date: Jun. 1, 2006

(54) Support structure for mounting components on vehicle

(75) Inventors: Akira Tanaka, Toyota-shi (JP); Yasuhiro Sakakibara, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-Ken (JP)

(21) Appl. No.: 11/280,350

(22) Filed: Nov. 17, 2005

(30) Foreign Application Priority Data
Nov. 26, 2004 (JP) 2004-342574

(51) Int. Cl. B60R 7/04

(52) U.S. Cl. 296/24.34

(57) ABSTRACT

A support structure used for installing a console to a vehicle has panels and a console box. The support structure has a main body attached to the vehicle. The main body is formed as a framework, and has attachment portions each corresponding to one of the panels and the console box. The panels and the console box are each directly attached to the corresponding attachment portion so that the console is coupled to the vehicle.

### BACKGROUND OF THE INVENTION

The present invention relates to a support structure for installing various vehicle components on a vehicle.

In general, a console box like as disclosed, for example, in Japanese Laid-Open Patent Publication No. 9-136575 (a box-shaped structure) is provided in a center console of a vehicle. The console box is formed by assembling a number of vehicle components such as a box main body and side panels. A center console having such a console box is installed in a vehicle in the following manner. First, a box main body having a bottom is assembled with front and rear brackets (support structure for mounting components on vehicle) provided on the floor of the passenger compartment. Thereafter, a pair of side panels are attached to the sides of the box main body. An upper panel is attached to the side panels. A rear end panel is attached to the rear ends of the side panels. In this manner, the center console having the console box is assembled in the vehicle.

In the center console having the above mentioned console box, most of the components from box main body to the rear end panel are successively assembled with the brackets. Specifically, each component is attached to another component that has been previously installed. That is, except for the box main body, no component is directly attached to the brackets. Therefore, as the components such as the box main body to the rear panel are successively installed, assembly errors among the components accumulate, which increases the assembly errors of the entire center console.

### SUMMARY OF THE INVENTION

Accordingly, it is an objective of the present invention to provide a support structure for mounting components on vehicle that improves the assembly accuracy of components.

To achieve the foregoing and other objectives of the present invention, a support structure used for installing a plurality of vehicle components on a vehicle is provided. The support structure has a main body attached to the vehicle. The main body has a plurality of attachment portions each corresponding to one of the vehicle components. The vehicle components are each directly attached to the corresponding attachment portion so as to be coupled to the vehicle.

The present invention also provides a support structure used for installing a console to a vehicle. The console has a plurality of panels and a console box. The support structure has a main body attached to the vehicle. The main body is formed as a framework, and has a plurality of attachment portions each corresponding to one of the panels and the console box. The panels and the console box are each directly attached to the corresponding attachment portion so that the console is coupled to the vehicle.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view illustrating a passenger compartment according to a preferred embodiment;

FIG. 2 is a cross-sectional view illustrating a rear portion of a center console according to the preferred embodiment;

FIG. 3 is a cross-sectional view taken along line 3-3 in FIG. 2;

FIG. 4 is a cross-sectional view taken along line 4-4 in FIG. 2;

FIG. 5 is a perspective view illustrating a main body according to the preferred embodiment;

FIG. 6 is a perspective view illustrating a main body according to the preferred embodiment; and

FIG. 7 is an exploded perspective view illustrating the center console of the preferred embodiment.

### DETAILED DESCRIPTION OF THE PREFERRED EMBODIMENTS

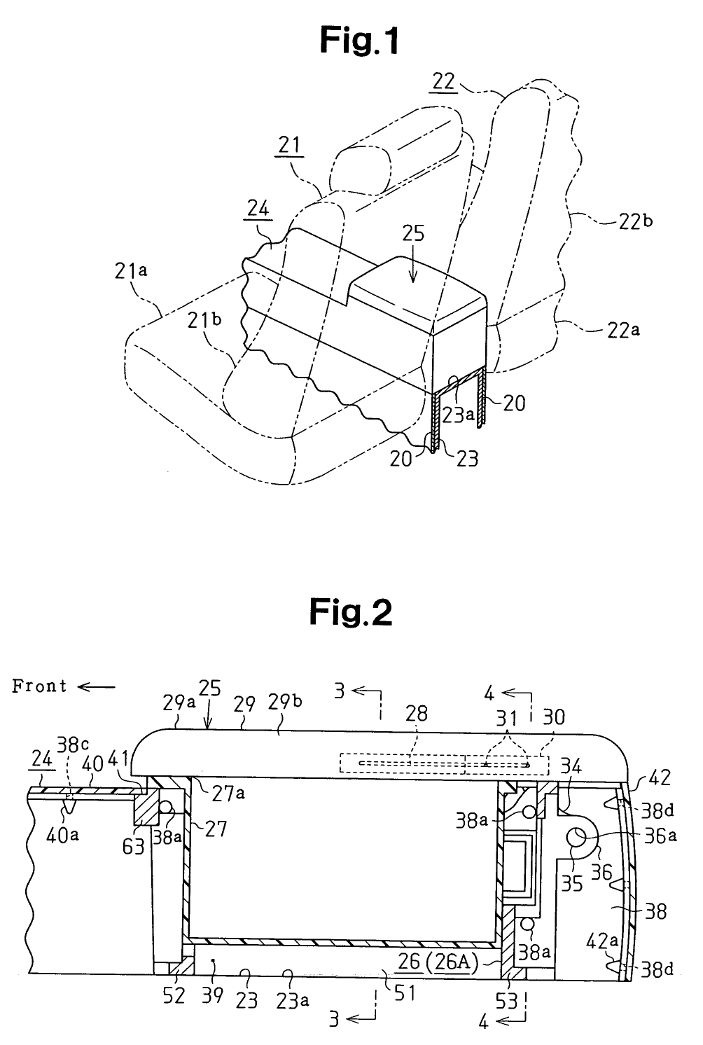

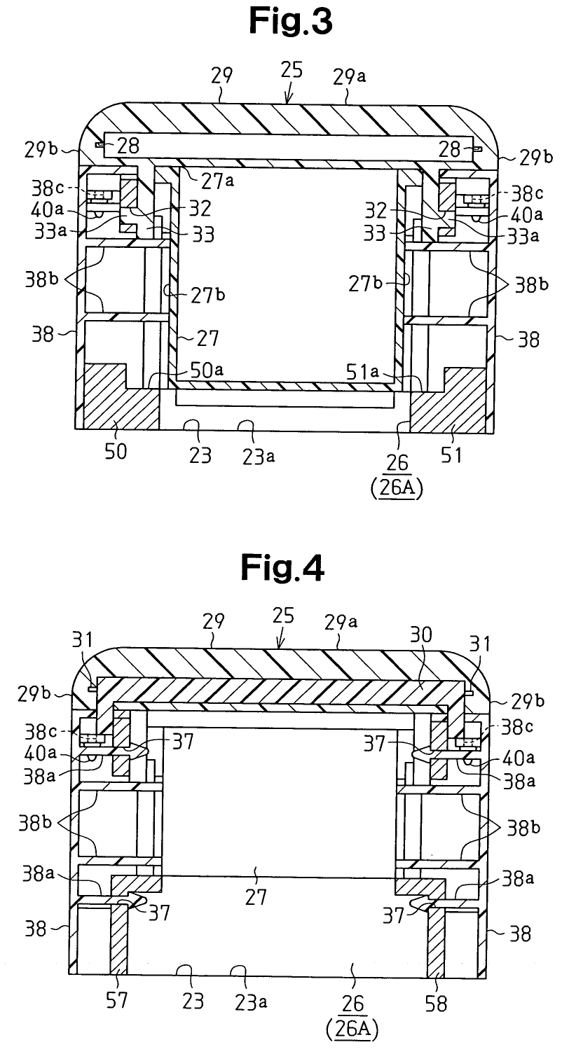

One embodiment of the present invention will now be described with reference to FIGS. 1 to 7. In the following, the fore-and-aft direction refers to a direction extending along the traveling direction of the vehicle. Also, unless specified otherwise, a vertical direction and a lateral direction are the same as the vertical direction and the lateral direction of the vehicle with respect to the forward direction, or the traveling direction, of the vehicle.

The structure of the passenger compartment of a vehicle will be described first.

As shown in FIG. 1, in the passenger compartment of the vehicle, a pair of left and right seats are arranged along the width of the vehicle. The seats are a driver's seat 21 and a passenger seat 22. The driver's seat 21 and the passenger seat 22 each have a seat portion 21a, 22a and a backrest 21b, 22b. A floor tunnel 23 is formed on the floor between the driver's seat 21 and the passenger seat 22. The floor tunnel 23 extends in along the fore-and-aft direction of the vehicle, and has a U-shaped cross-section with open side facing downward. A carpet 20 is placed on the outer surface of the floor tunnel 23 to improve the appearance of the compartment floor. The floor tunnel 23 has an upper surface 23a that is lower than the seat portions 21a, 22a of the driver's seat 21 and the passenger seat 22. A center console 24 is provided on the floor tunnel 23 to extend along the fore-and-aft direction between the driver's seat 21 and the passenger seat 22. The center console 24 has a console box 25 at a rear portion to accommodate small articles.

The structure of the center console 24 will now be described.

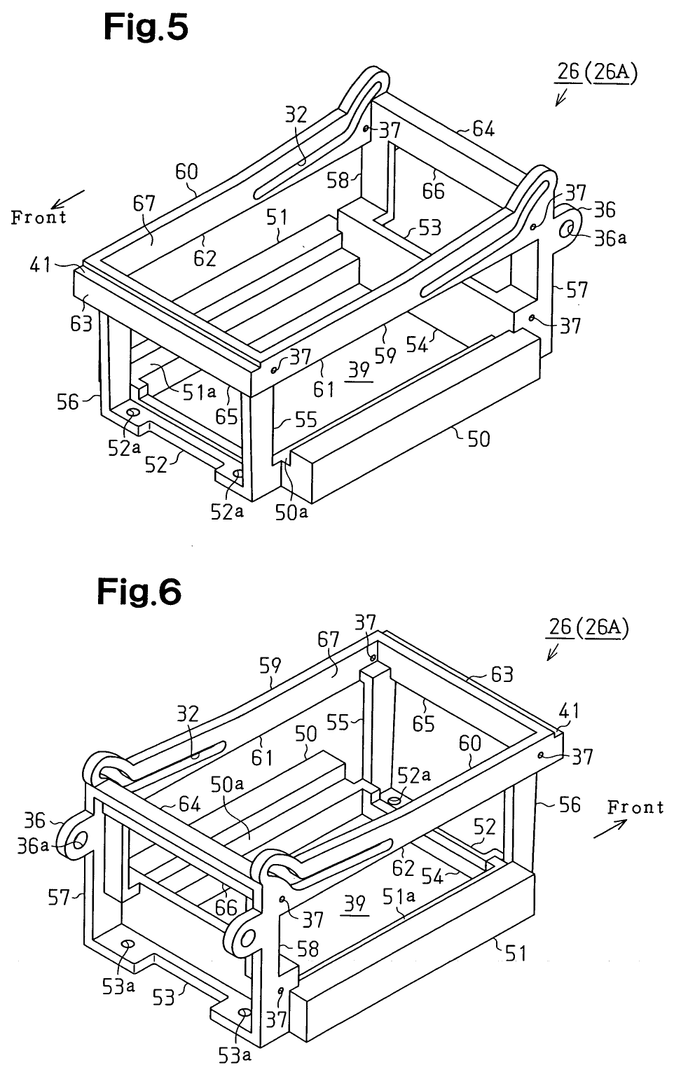

As shown in FIGS. 2, 3, and 4, a main body 26A of a support structure 26 for vehicle is fixed to the upper surface 23a of the floor tunnel 23 with bolts (not shown). The main body 26A is formed by casting light metal having rigidity such as magnesium and aluminum. As shown in FIGS. 5 and 6, the main body 26A is substantially a rectangular parallelepiped framework and laterally symmetrical. That is, the main body 26A has a lower left bar 50 extending in the fore-and-aft direction, a lower right bar 51 extending parallel to the lower left bar 50 with a predetermined space in between. The lower left bar 50 and the lower right bar 51 each have a step 50a, 51a so that the inner sections are lower than the outer sections.

A plate-like lower front bar 52 extends between the front ends of the lower left bar 50 and the lower right bar 51. A lower rear bar 53 having an L-shaped cross-section extends between the rear ends of the lower left bar 50 and the lower right bar 51. A pair of holes 52a are formed in the lower front bar 52, and a pair of holes 53a are formed in the lower rear bar 53. The holes 52a, 53a are used for securing the main body 26A to the upper surface 23a of the floor tunnel 23 with bolts (not shown). The lower left bar 50, the lower right bar 51, the lower front bar 52, and the lower rear bar 53 define a substantially rectangular lower opening 54.

A plate-like front left bar 55 extends vertically from the joint between the lower left bar 50 and the lower front bar 52. A plate-like front right bar 56 extends vertically from the joint between the lower right bar 51 and the lower front bar 52. A rear left bar 57 having an L-shape cross-section extends vertically from the joint between the lower left bar 50 and the lower rear bar 53. A rear right bar 58 having an L-shaped cross-section extends vertically from the joint between the lower right bar 51 and the lower rear bar 53.

A pair of attachment holes 37 (attachment portions) are formed in the rear left bar 57. The attachment holes 37 are vertically spaced by a predetermined distance. A pair of attachment holes 37 (attachment portions) are formed in the rear right bar 58. The attachment holes 37 are vertically spaced by a predetermined distance and correspond to the attachment holes 37 of the rear left bar 57. A semi-circular plate-like shaft support 36 extends rearward from the rear face of each of the rear left bar 57 and the rear right bar 58. The shaft supports 36 each have a through hole 36a to receive a pivot shaft 35 (see FIG. 2).

A plate-like upper left bar 59 extends between the upper ends of the front left bar 55 and the rear left bar 57. A plate-like upper right bar 60 extends between the upper ends of the front right bar 56 and the rear right bar 58. The lower left bar 50, the front left bar 55, the rear left bar 57, and the upper left bar 59 define a substantially rectangular left opening 61. The lower right bar 51, the front right bar 56, the rear right bar 58, and the upper right bar 60 define a substantially rectangular right opening 62. An attachment hole (attachment portion) 37 is formed in a front end of the upper left bar 59. An attachment hole (attachment portion) 37 is formed in a front end of the upper right bar 60 to correspond to the attachment hole 37 of the upper left bar 59.

A guide groove 32 is formed in each of the upper left bar 59 and the upper right bar 60, extending from a center to a rear end with respect to the fore-and-aft direction. The guide grooves 32 are formed as elongated hole and function as attachment portions. The guide grooves 32 are inclined upward toward the rear ends. The inclination angle of the guide grooves 32 at the rear end portions with respect to the fore-and-aft direction is steeper than the inclination angle of the guide grooves 32 at the front end and middle portions in the fore-and-aft direction.

A plate-like upper front bar 63 extends between the front ends of the upper left bar 59 and the upper right bar 60. A plate-like upper rear bar 64 extends between the rear ends of the upper left bar 59 and the upper right bar 60. A step-like engaging portion (attachment portion) 41 is formed on the upper surface of the upper front bar 63, so that the rear portion of the upper front bar 63 is higher than the front portion.

The lower front bar 52, the front left bar 55, the front right bar 56, and the upper front bar 63 define a substantially rectangular front opening 65. The lower rear bar 53, the rear left bar 57, the rear right bar 58, and the upper rear bar 64 define a substantially rectangular rear opening 66. The upper left bar 59, the upper right bar 60, the upper front bar 63, and the upper rear bar 64 define a substantially rectangular upper opening 67. The lower left bar 50, the lower right bar 51, the lower front bar 52, the lower rear bar 53, the front left bar 55, the front right bar 56, the rear left bar 57, the rear right bar 58, the upper left bar 59, the upper right bar 60, the upper front bar 63, and the upper rear bar 64 define an insertion portion 39 inside. The insertion portion 39 functions as an attachment portion.

Various types of vehicle components that form the center console 24 and the console box 25 are assembled with the main body 26A of the support structure 26 for vehicle, which is constructed as above. That is, as shown in FIGS. 2, 3, and 4, the insertion portion 39 of the main body 26A receives a box main body 27 of the console box 25 through the upper opening 67, such that the box main body 27 is installed in the main body 26A with the lower end supported by the steps 50a, 51a. The box main body 27 is shaped like a rectangular box having an upper opening 27a. A lid 29 of the console box 25 is provided on the upper portion of the box main body 27 to selectively open and close the upper opening 27a. A pair of left and right arms 33 extend downward from the lower end of the lid 29. A guide pin 33a extends outward from a lower end portion of each arm 33. Each guide pin 33a is slidably engaged with the corresponding guide groove 32.

The lid 29 includes a rectangular plate-like top 29a and left and right side plates 29b that extend downward from the left and right sides of the top 29a. A slide groove 28 is formed on an inner surface of each side plate 29b. Each slide groove 28 extends along the fore-and-aft direction A rectangular base panel 30 is provided between the side plates 29b. A pair of front and rear slide pins 31 extend from each side of the base panel 30. Each pair of the slide pins 31 are slidably engaged with the corresponding slide groove 28 and permit the base panel 30 and the lid 29 to move relative to each other in the fore-and-aft direction. A pair of hinge plates 34 extend downward from the lower end of the base panel 30. The hinge plates 34 are secured to the shaft supports 36 with the pivot shaft 35 extending through the through holes 36a. The hinge plate 34 permits the base panel 30 to pivot upward and downward about the pivot shaft 35 relative to the box main body 27.

The attachment holes 37 are formed in the left and right sides of the main body 26A (in this embodiment, three on each side). The left and right side walls of the center console 24 are formed by rectangular side panels 38, which are vehicle components. A plurality of pins 38a project from the inner surface of each side panel 38 to correspond to the attachment holes 37. Engagement of the attachment holes 37 and the pins 38a secure the side panels 38 to the left and right sides of the main body 26A. A U-shaped boss portion 38b project inward from the inner surface of each side panel 38. The edge of each boss portion 38b is welded to the corresponding one of outer side walls 27b of the box main body 27.

Attachment holes 38c are formed in an upper surface of each side panel 38 in a section forward of the main body 26A. The attachment holes 38c are arranged along the fore-and-aft direction and spaced at a predetermined interval. A rectangular plate-like upper panel 40, which is a vehicle component, is provided on the upper surfaces of the side panels 38 to bridge the upper surfaces. Pins 40a project downward from the lower side of each of the left and right edges of the upper panel 40. The pins 40a correspond to and are engaged with the attachment holes 38c. In the engaged state, the rear edge of the upper panel 40 is engaged with the engaging portion 41 of the main body 26A.

Attachment holes 38d are formed in a rear surface of each side panel 38. The attachment holes 38d are arranged along the vertical direction and spaced at a predetermined interval. A rectangular plate-like rear end panel 42, which is a vehicle component, is provided on the upper surfaces of the side panels 38 to extend between the upper surfaces with each other. Pins 42a project forward from the left and right end portions of the front side of the rear end panel 42. The pins 42a correspond to and are engaged with the attachment holes 38d.

The assembly procedure of the center console 24 will now be described.

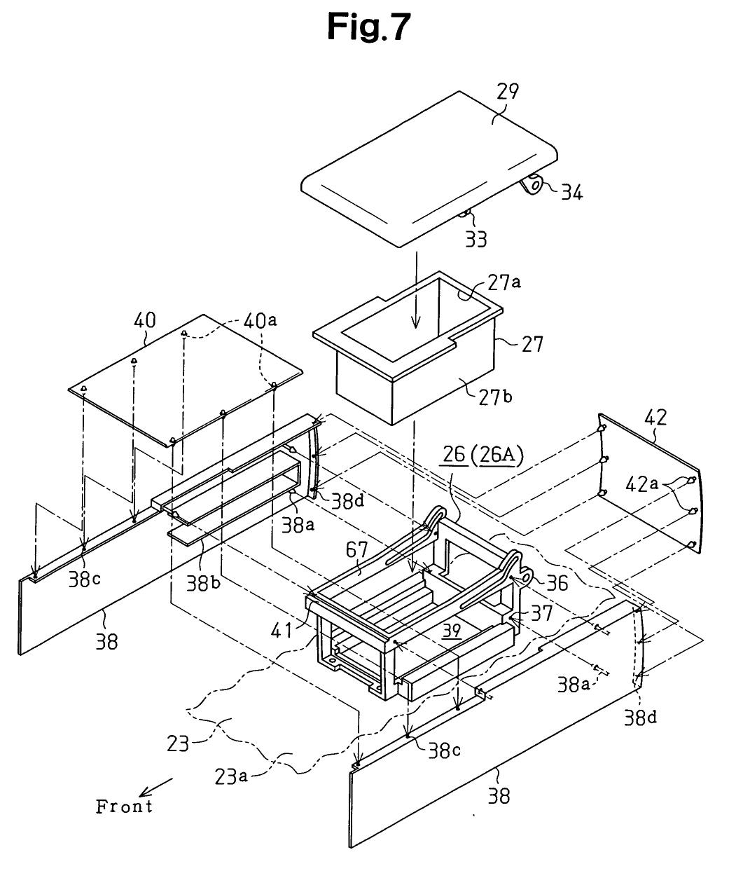

When installing the center console 24 in the passenger compartment of a vehicle, the main body 26A is fixed to the upper surface 23a of the floor tunnel 23 with bolts (not shown) as shown in FIG. 7. Subsequently, the box main body 27 is inserted into the insertion portion 39 through the upper opening 67, thereby assembling the box main body 27 with the main body 26A. At this time, the bottom of the box main body 27 is supported by the steps 50a, 51a. Thereafter, the lid 29 is attached to the shaft supports 36 with the pivot shaft 35, and the guide pins 33a of the lid 29 are engaged with the guide grooves 32 of the main body 26A.

Next, the pins 38a of the side panels 38 are fitted in the attachment holes 37 of the main body 26A, thereby attaching the side panels 38 to the left and right sides of the main body 26A. The inner edges of the boss portions 38b of the side panels 38 are welded to the left and right outer side walls 27b of the box main body 27. Subsequently, after engaging the rear edge of the upper panel 40 with the engaging portion 41 of the main body 26A to determine the position of the upper panel 40, the pins 40a of the upper panel 40 are fitted into the attachment holes 38c of the side panels 38, thereby attaching the upper panel 40 to the side panels 38. Then, the pins 42a of the rear end panel 42 are fitted in the attachment holes 38d of the side panels 38, thereby attaching the rear end panel 42 to the side panels 38.

Then, in the center console 24, the vehicle components that form the center console 24 (the box main body 27, the lid 29, the side panels 38, the upper panel 40), are each separately installed on the upper surface 23a of the floor tunnel 23 using the main body 26A as a reference. In this case, each of the vehicle components (the box main body 27, the lid 29, the side panels 38, the upper panels 40) is directly attached to the main body 26A.

The above described embodiment has the following advantages.

(1) Since the box main body 27, the lid 29, the side panels 38, and the upper panel 40 are each installed on the upper surface 23a of the floor tunnel 23 with reference to the main body 26A, assembly errors of these components are prevented from being accumulated. Therefore, the assembly accuracy of the box main body 27, the lid 29, the side panels 38, and the upper panel 40 relative to the vehicle is improved.

(2) The main body 26A is formed by casting light metal having rigidity such as magnesium and aluminum. For example, in a case of a lateral collision, the main body 26A receives the impact of the collision through the seat on the corresponding side. This reduces the deformation of the passenger compartment upon collision. Since the main body 26A has rigidity, the main body 26A is scarcely deformed by attaching a number of vehicle components or heavy components to the main body 26A. Thus, the above mentioned vehicle components are attached to the main body 26A with high accuracy.

(3) The main body 26A is formed as a framework having a plurality of bars (for example, the upper left bar 59 and the upper right bar 60). The weight of the main body 26A is thus reduced.

(4) Since the box main body 27 of the console box 25 is inserted into the insertion portion 39 of the main body 26A, the rigidity of the console box 25 is improved. This ultimately increases the rigidity of the center console 24.

(5) When installing the center console 24, the single main body 26A is used instead of a pair of conventional brackets. This reduces the number of the components.

The above embodiment may be modified as follows.

The main body 26A may be made of a thermoplastic resin, and the vehicle components such as the side panels 38 and the box main body 27 may be directly welded to the main body 26A. In this case, the portions of the vehicle components that are welded to the main body 26A function as attachment portions.

In the illustrated embodiment, the main body 26A is used for installing the center console 24. However, the main body 26A may be used for installing, for example, a glove box.

The shape of the main body 26A is not limited to a framework, but may be shaped as a box with a bottom.

1. A support structure used for installing a plurality of vehicle components on a vehicle, the support structure having a main body attached to the vehicle, the main body having a plurality of attachment portions each corresponding to one of the vehicle components,
wherein the vehicle components are each directly attached to the corresponding attachment portion so as to be coupled to the vehicle.

2. The support structure according to claim 1, wherein the vehicle components include a box-shaped vehicle component, and the attachment portions include an insertion portion into which the box-like vehicle component is inserted.

3. The support structure according to claim 1, wherein the vehicle components include a panel having a pin projecting therefrom, the attachment portions include a hole that corresponds to the pin, wherein the pin is engaged with the hole so that the panel is attached to the main body.

4. The support structure according to claim 1, wherein the vehicle has a pair of seats that are arranged along the width of the vehicle, and the main body is fixed to a floor of the vehicle passenger compartment between the seats.

5. The support structure according to claim 1, wherein the main body is formed as a framework having a plurality of bars.

6. The support structure according to claim 1, wherein the main body is made of a material having rigidity.

7. The support structure according to claim 6, wherein the main body is made of magnesium or aluminum.

8. A support structure used for installing a console to a vehicle, the console having a plurality of panels and a console box, the support structure having a main body attached to the vehicle, the main body being formed as a framework, the main body having a plurality of attachment portions each corresponding to one of the panels and the console box,
wherein the panels and the console box are each directly attached to the corresponding attachment portion so that the console is coupled to the vehicle.

9. The support structure according to claim 8, wherein the attachment portions include an insertion portion into which the consol box is inserted.

10. The support structure according to claim 8, wherein the panels include a panel having a pin projecting therefrom, the attachment portions include a hole that corresponds to the pin, wherein the pin is engaged with the hole so that the panel is attached to the main body.

11. The support structure according to claim 8, wherein the vehicle has a pair of seats that are arranged along the width of the vehicle, a floor tunnel is provided on a floor of the vehicle passenger compartment between the seats, and wherein the main body is fixed to the floor tunnel.

12. The support structure according to claim 8, wherein the main body is made of a light metal having rigidity.

13. The support structure according to claim 12, wherein the main body is made of magnesium or aluminum.
